(19) United States
(12) Patent Application Publication
(10) Pub. No.: US 2025/0320839 A1
(43) Pub. Date: Oct. 16, 2025

(54) CONTROL SYSTEM FOR INTERNAL COMBUSTION ENGINE, INTERNAL COMBUSTION ENGINE CONFIGURED TO CONTROL COMBUSION, AND METHOD OF CONTROL THEREOF

(71) Applicant: Cummins Power Generation Inc., Minneapolis, MN (US)

(72) Inventors: Cathy Youngmi Choi, Minneapolis, MN (US); Axel O. zur Loye, Battle Ground, WA (US)

(73) Assignee: Cummins Power Generation Inc., Minneapolis, MN (US)

(21) Appl. No.: 18/869,778

(22) PCT Filed: May 26, 2023
(86) PCT No.: PCT/US2023/023728

§ 371 Date: Nov. 26, 2024

Related U.S. Application Data
(60) Provisional application No. 63/346,779, filed on May 27, 2022.

(51) Int. Cl. F02D 41/14; F02D 19/02; F02D 21/08

(52) U.S. Cl. CPC F02D 41/14; F02D 19/02; F02D 21/08

(57) ABSTRACT

A control system for an internal combustion engine includes a temperature sensor configured to measure an exhaust temperature from a cylinder of the internal combustion engine, a NOx sensor configured to measure an exhaust NOx amount from the cylinder, and a controller operably connected to the temperature sensor and the NOx sensor. The controller is configured to: receive the measured exhaust temperature from the temperature sensor and the measured exhaust NOx amount from the NOx sensor, calculate a current combustion performance of the cylinder based on the measured exhaust temperature and the measured exhaust NOx amount, determine whether to adjust one or more of a plurality of operational parameters, and control the one or more of the plurality of operational parameters based on the current combustion performance.

### CROSS REFERENCE TO RELATED APPLICATIONS

The present application claims benefit of priority to U.S. Provisional Patent Application No. 63/346,779, titled “Control System for Internal Combustion Engine, Internal Combustion Engine Configured to Control Combustion, and Method of Control Thereof,” filed May 27, 2022, which is incorporated herein by reference in its entirety.

### TECHNICAL FIELD

The present disclosure relates to controlling internal combustion engine systems and methods thereof.

### BACKGROUND

In an internal combustion engine system including a multi-cylinder engine (e.g., compression ignition or spark ignition internal combustion engines, etc.), combustion across the cylinders of the multi-cylinder engine is an important aspect of engine performance. Increasingly stringent environmental standards and imperatives to reduce emissions, such as nitrogen oxides (NOx), have led to increased demand for internal combustion engine systems with improved combustion performance.

### SUMMARY

In some embodiments, a control system for an internal combustion engine includes a temperature sensor configured to measure an exhaust temperature from a cylinder of the internal combustion engine, a NOx sensor configured to measure an exhaust NOx amount from the cylinder, and a controller operably connected to the temperature sensor and the NOx sensor, the controller configured to: receive the measured exhaust temperature from the temperature sensor and the measured exhaust NOx amount from the NOx sensor, calculate a current combustion performance of the cylinder based on the measured exhaust temperature and the measured exhaust NOx amount, determine whether to adjust one or more of a plurality of operational parameters, and control the one or more of the plurality of operational parameters based on the current combustion performance.

In some embodiments, the plurality of operational parameters includes at least one of an air-fuel ratio, a fuel composition, an exhaust gas recirculation fraction, a spark timing value, an injection timing value, a timing of a valve opening or closing event, or a geometric compression ratio.

In some embodiments, the cylinder is one of a plurality of cylinders of the internal combustion engine, each of the plurality of cylinders being provided with a respective NOx sensor and a respective temperature sensor.

In some embodiments, the controller is configured to control the target combustion performance of each of the plurality of cylinders to balance a collective combustion performance among the plurality of cylinders.

In some embodiments, the controller is configured to adjust at least one of an overall internal combustion engine air-fuel ratio or an overall internal combustion engine exhaust gas recirculation fraction in response to the measured exhaust temperature and the measured exhaust NOx amount.

In some embodiments, the internal combustion engine is a port-injected hydrogen fueled engine or a direct-injected hydrogen fueled engine.

In some embodiments, an internal combustion engine system configured to control combustion includes an internal combustion engine having a plurality of cylinders, each having a temperature sensor and a NOx sensor; and a control system configured to control the plurality of cylinders of the internal combustion engine. The control system includes a controller configured to: receive information relating to a plurality of operational parameters of each of the plurality of cylinders of the internal combustion engine; measure, for each of the plurality of cylinders of the internal combustion engine, an exhaust temperature from the temperature sensor and an exhaust NOx amount from the NOx sensor; evaluate, for each of the plurality of cylinders of the internal combustion engine, one or more of the plurality of operational parameters with respect to the measured exhaust temperature and the measured exhaust NOx amount; and adjust, for one or more of the plurality of cylinders of the internal combustion engine, one or more of the plurality of operational parameters to control the combustion among the plurality of cylinders.

In some embodiments, each cylinder of the plurality of cylinders includes an exhaust manifold or an exhaust port configured to receive an exhaust gas, the temperature sensor and the NOx sensor being coupled to the exhaust manifold or the exhaust port to measure the exhaust temperature and the exhaust NOx amount of the exhaust gas.

In some embodiments, the plurality of operational parameters include (i) an exhaust gas recirculation fraction of an exhaust gas recirculation system of the internal combustion engine, (ii) a spark timing value of an ignition system of the internal combustion engine, (iii) an injection duration and an injection pressure of a fuel injection system of the internal combustion engine, (iv) a timing of a valve opening or closing event of a cam of the internal combustion engine, (v) an air-fuel ratio of the internal combustion engine, (vi) a geometric compression ratio of one or more of the plurality of cylinders of the internal combustion engine, and (vii) a fuel composition. The controller is configured to receive information relating to each of the plurality of operational parameters to evaluate the combustion of the internal combustion engine.

In some embodiments, the internal combustion engine system further includes a knock sensor communicatively coupled to the controller and configured to measure engine knock, the controller being configured to adjust the one or more operational parameters based on the measured engine knock and, for one or more of the plurality of cylinders, the measured exhaust temperature and the measured exhaust NOx amount.

In some embodiments, the controller is configured to determine whether an overall engine combustion performance differs from a target engine performance, and to adjust an overall internal combustion engine air-fuel ratio and an overall internal combustion engine exhaust gas recirculation fraction in response to the measured exhaust temperature and the measured exhaust NOx amount for one or more cylinder of the plurality of cylinders.

In some embodiments, the controller is configured to adjust the estimated plurality of operating conditions to balance the plurality of operating conditions across the plurality of cylinders.

In some embodiments, the internal combustion engine is one of a spark-ignited engine, a pilot-ignited engine, a compression-ignited engine, or a dual fuel engine.

In some embodiments, the controller is configured to determine whether a knock has occurred in response to the measured exhaust temperature and the measured exhaust NOx amount for one or more of the plurality of cylinders.

In some embodiments, the internal combustion engine is at least one of a hydrogen fueled engine, a natural gas fueled engine, a propane fueled engine, or an ammonia fueled engine.

In some embodiments, a method for controlling an internal combustion engine system includes measuring, by a temperature sensor of a cylinder of the internal combustion engine, an exhaust temperature of an exhaust gas of the cylinder; measuring, by a NOx sensor of the cylinder, an exhaust NOx amount of the exhaust gas; receiving, by a controller, the measured exhaust temperature and the measured exhaust NOx amount from the temperature sensor and the NOx sensor; determining a target combustion performance of the cylinder based on the measured exhaust temperature and the measured exhaust NOx amount; determining whether to adjust one or more of a plurality of operational parameters; and controlling the one or more of the plurality of operational parameters based on the target combustion performance.

In some embodiments, determining whether to adjust the plurality of operational parameters includes determining whether to adjust one or more of an air-fuel ratio, a fuel composition, an exhaust gas recirculation fraction, a spark timing value, an injection timing value, a timing of a valve opening or closing event, or a geometric compression ratio.

In some embodiments, the method further includes adjusting, by the controller, one or more of the plurality of operational parameters to balance combustion performance among a plurality of cylinders.

In some embodiments, the method further includes measuring a knock via a knock sensor coupled to the engine; and adjusting, by the controller, at least one of an overall internal combustion engine air-fuel ratio or an overall internal combustion engine exhaust gas recirculation fraction in response to the detected knock, the measured exhaust temperature, and the measured exhaust NOx amount for each cylinder of the plurality of cylinders of the internal combustion engine.

In some embodiments, the step of measuring the exhaust temperature and the NOx amount of the exhaust gas of the cylinder of the internal combustion engine includes measuring the exhaust temperature and the NOx amount of the exhaust gas in an exhaust manifold or an exhaust port of the cylinder of the internal combustion engine, the temperature sensor and the NOx sensor being coupled to one of the exhaust manifold or the exhaust port.

It is to be understood that both the foregoing general description and the following detailed description are exemplary and explanatory only, and are not restrictive of the present teachings.

### BRIEF DESCRIPTION OF THE DRAWINGS

The disclosure will become more fully understood from the following detailed description, taken in conjunction with the accompanying figures, wherein like reference numerals refer to like elements unless otherwise indicated, in which:

FIG. 1 is a schematic illustration of a portion of an internal combustion engine system, according to an exemplary embodiment;

FIG. 2 is a schematic illustration of a portion of the internal combustion engine system of FIG. 1, according to an exemplary embodiment;

FIG. 3 is a schematic illustration of a cylinder and a control system of the internal combustion engine system of FIG. 1, according to an exemplifying embodiment; and

FIG. 4 is a flowchart illustrating a method for controlling the internal combustion engine system, according to an exemplary embodiment.

### DETAILED DESCRIPTION

Following below are more detailed descriptions of various concepts related to, and implementations of methods and systems for providing control of an internal combustion engine system. The various concepts introduced above and discussed in greater detail below may be implemented in any of a number of ways, as the described concepts are not limited to any particular manner of implementation. Examples of specific implementations and applications are provided primarily for illustrative purposes.

Generally, embodiments of this disclosure relate to internal combustion engine systems and control systems to balance combustion across a multi-cylinder engine while reducing NOx emissions. In some embodiments, the systems balance combustion across a multi-cylinder engine while reducing the likelihood of engine knock and/or misfire. Such systems can include a temperature sensor and a NOx sensor to measure an exhaust temperature and an exhaust NOx amount. Some embodiments balance combustion performance in a multi-cylinder engine by measuring an exhaust temperature and an exhaust NOx amount to determine, for each cylinder, whether to adjust a plurality of operational parameters affecting combustion performance. Some systems disclosed herein measure both the exhaust temperature and the exhaust NOx amount. Such systems can permit more comprehensive evaluation of operational parameters affecting combustion. The systems and techniques described herein can be conducive for hydrogen engines and/or engines using fuel containing hydrogen (among other types of engines and/or fuel) because, for each cylinder, the exhaust temperature and the exhaust NOx amount are used to evaluate and adjust the plurality of operations conditions of each cylinder. Such systems can permit more precise monitoring and/or controlling of combustion to reduce variations between each cylinder.

The present disclosure sets forth techniques that account for cylinder-to-cylinder combustion variation, which is particularly acute in hydrogen internal combustion engines.

In particular, various exemplary embodiments can provide for balancing combustion performance and reducing NOx emissions in a multi-cylinder engine such as a multi-cylinder hydrogen internal combustion engine. Thus, some embodiments can have reduced costs and/or physical modifications associated with in-cylinder pressure sensing that require physical installation of the in-cylinder pressure sensor in a cylinder head. Further, the amount of information that is pertinent to the reduction of NOx emissions can be increased by utilizing a combination of the exhaust temperature and the exhaust NOx amount.

The production of NOx during combustion is largely driven by a combustion temperature. Exhaust port temperature in diesel engines and dual fuel engines can be used to identify an imbalance between cylinder combustion performance. However, exhaust port temperature is not necessarily indicative of combustion performance because of, for example, fuel dilution, uneven fuel mixture, and localized hot spots during combustion, or any combination thereof. Therefore, exhaust port temperature, alone, is just one parameter of combustion performance and provides less information for combustion control in diluted charge (e.g., lean burn, cooled exhaust gas recirculation (EGR), etc.) spark ignition engines or pilot-injected engines.

As used herein, the term “charge” refers to the mixture of air, fuel, and exhaust gases that exists within the cylinder, or in the intake manifold.

Some embodiments provide control techniques of hydrogen internal combustion engines (among others) which do not permit the introduction of hydrogen fuel far enough upstream of the cylinder head to provide a well-mixed fuel-air charge to the intake manifold (e.g., by introducing hydrogen fuel through a mixer located upstream of the inlet of the compressor of the turbocharger, etc.). Hydrogen (or fuel mixtures that include at least 5% hydrogen by volume), are highly combustible and presents significant backfire management challenges especially in engines where hydrogen fuel is not well mixed. The present disclosure provides combustion balancing across multiple cylinders of engines that receive fuel mixtures containing hydrogen (e.g., natural gas-hydrogen mixture, etc.) and may or may not provide a well mixed hydrogen and liquid fuel mixture for combustion. Such mixtures can vary in hydrogen content (e.g., a fuel mixture including hydrogen, pure hydrogen fuel, etc.).

The exemplary techniques set forth herein address unique challenges in balancing combustion in a multi-cylinder engine that is a hydrogen engine or otherwise utilizes a hydrogen fuel mixture. As an example of such challenges, engines not designed for an equal charge flow distribution across multiple cylinders and/or engines using fuel mixtures containing hydrogen can provide varying air-fuel ratios to each cylinder as well as stratification (i.e., spatial variations, etc.) of the air-fuel ratio within each cylinder. Although introducing a charge flow upstream of a turbocharger typically provides a more even fuel mixture, such upstream-mixed systems are ill-suited for hydrogen fuel mixtures because they create a large volume of highly combustible fuel mixture in the intake system and increase the probability of backfire. Further, the internal combustion engine systems and control systems described herein can provide more robust control for balancing combustion performance. Particularly, rather than relying upon a single parameter, the systems herein can measure both the exhaust temperature and the exhaust NOx amount to evaluate and adjust a plurality of operational parameters affecting combustion performance. In this way, the systems described herein are able to more precisely monitor and control, for each cylinder, combustion to reduce variation between each cylinder. Accordingly, the systems are particularly advantageous for hydrogen engines and/or engines using hydrogen fuel mixtures where cylinder combustion variation is significant.

Implementations described herein relate to an internal combustion engine system configured to control combustion of an internal combustion engine and to a method of controlling such an internal combustion engine. The internal combustion engine system includes a plurality of cylinders each having a temperature sensor and a NOx sensor, and a control system configured to control the plurality of cylinders of the internal combustion engine. The control system includes a controller configured to receive information relating to a plurality of operational parameters of each of the plurality of cylinders of the internal combustion engine; measure, for each of the plurality of cylinders of the internal combustion engine, an exhaust temperature from the temperature sensor and a NOx amount from the NOx sensor; evaluate, for each of the plurality of cylinders of the internal combustion engine, one or more of the plurality of operational parameters with respect to the measured exhaust temperature and the measured NOx amount; and adjust, for one or more of the plurality of cylinders of the internal combustion engine, one or more of the plurality of operational parameters to control the combustion among the plurality of cylinders.

The present application provides for at least one exemplary embodiment of an internal combustion engine system 20 which is configured to control combustion in an internal combustion engine 30 of a vehicle (e.g., passenger vehicle, commercial vehicle, construction vehicle, etc.) using a control system 120. The internal combustion engine system 20 may also be configured to control combustion in an internal combustion engine 30 of a variety of other equipment powered by the engine 30 (e.g., stationary equipment, such as a generator set, a locomotive or other rail equipment, agricultural or construction equipment, an industrial vehicle such as a mine haul truck, a marine vessel, a plane, a helicopter, or other equipment capable of flight, etc.). Specifically, the internal combustion engine system 20 controls combustion using the control system 120 configured to control a plurality of cylinders 31 of the internal combustion engine 30 (e.g., a multi-cylinder engine, etc.) to balance combustion performance among the plurality of cylinders 31. As explained in more detail herein, the internal combustion engine system 20 controls combustion to balance combustion performance among the plurality of cylinders 31 based on both of a measured exhaust gas temperature and a measured exhaust gas NOx amount. The exhaust temperature and the exhaust NOx amount are used to (i) calculate a target combustion performance of the plurality of cylinders 31, (ii) determine whether to adjust one or more of a plurality of operational parameters based on the target combustion performance, and (iii) adjust, for one or more of the plurality of cylinders 31 of the internal combustion engine 30, one or more of the plurality of operational parameters to control the combustion among the plurality of cylinders 31.

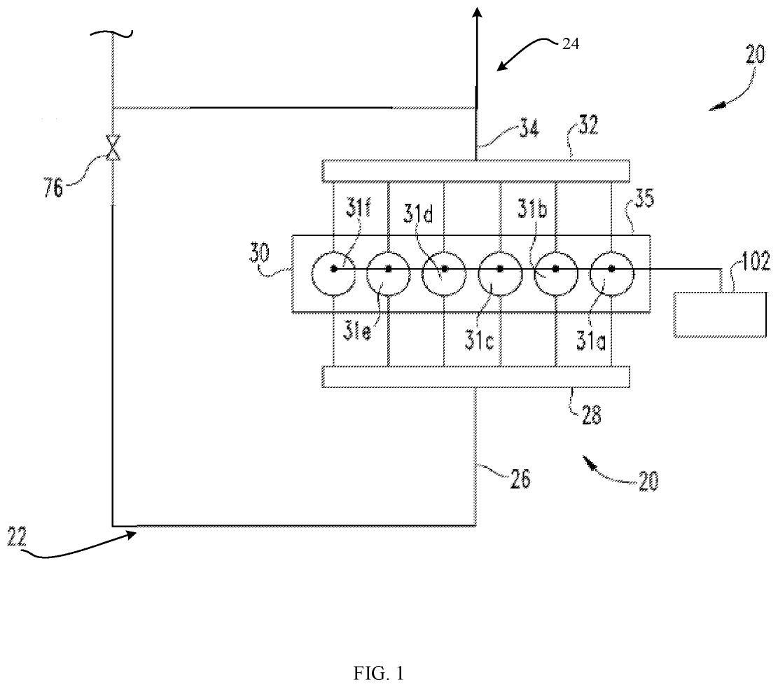

Referring to the figures generally, FIGS. 1-3 depict an exemplary control system 120 of the internal combustion engine system 20. The internal combustion engine system 20 is configured to control combustion and includes an internal combustion engine 30 having a plurality of cylinders 31, each having a temperature sensor 202 and a NOx sensor 204; and a control system 120 configured to control the plurality of cylinders 31 of the internal combustion engine 30. The control system 120 includes a controller 200 configured to receive information relating to a plurality of operational parameters of each of the plurality of cylinders 31 of the internal combustion engine 30. The controller 200 is further configured to measure, for each of the plurality of cylinders 31 of the internal combustion engine 30, an exhaust temperature from the temperature sensor 202 and an exhaust NOx amount from the NOx sensor 204. In addition, the controller 200 is further configured to evaluate, for each of the plurality of cylinders 31 of the internal combustion engine 30, one or more of the plurality of operational parameters with respect to the measured exhaust temperature and the measured exhaust NOx amount. Further still, the controller 200 is configured to adjust, for one or more of the plurality of cylinders 31 of the internal combustion engine 30, one or more of the plurality of operational parameters to control the combustion among the plurality of cylinders 31.

Further, in some embodiments, a control system 120 for an internal combustion engine 30 includes a temperature sensor 202 configured to measure, in an exhaust manifold 32, an exhaust gas temperature from a cylinder 31 of the internal combustion engine 30. The control system 120 further includes a NOx sensor 204 configured to measure, in the exhaust manifold 32, an exhaust NOx amount from the cylinder 31. In addition, the control system 120 includes a controller 200 operably connected to the temperature sensor 202 and the NOx sensor 204. The controller 200 is configured to receive the measured exhaust gas temperature from the temperature sensor 202 and the measured exhaust NOx amount from the NOx sensor 204, calculate a target combustion performance of the cylinder 31 based on the measured exhaust temperature and the measured exhaust NOx amount, and determine whether to adjust one or more of a plurality of operational parameters and control the one or more of the plurality of operational parameters based on the target combustion performance.

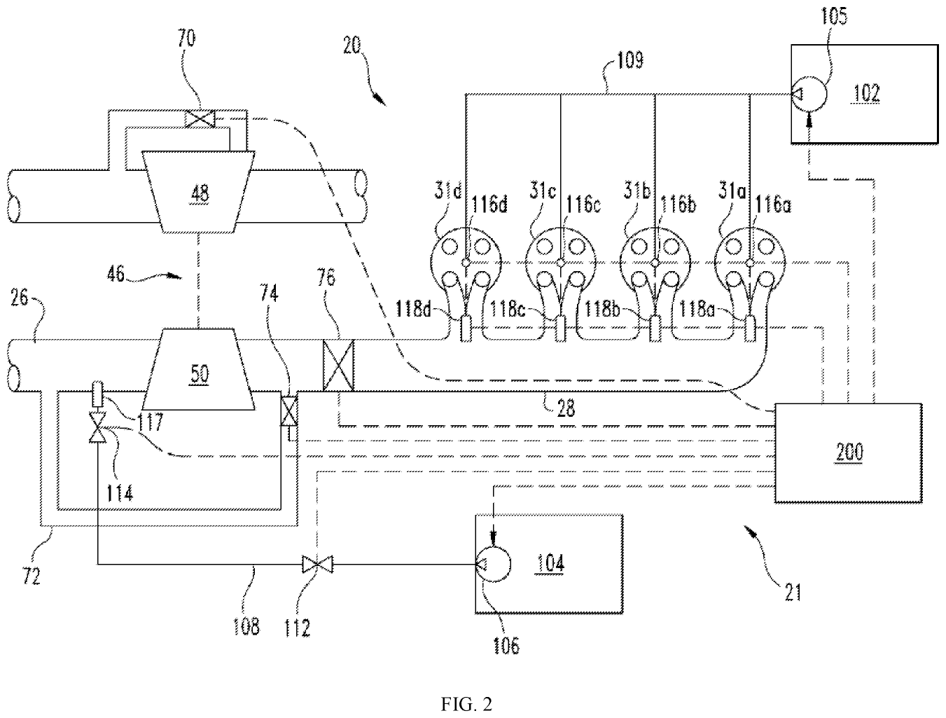

FIGS. 1-2 are schematic illustrations of portions of the internal combustion engine system 20, according to an exemplary embodiment. FIG. 2 is a schematic illustration of the cylinder 31 and the control system 120 of the internal combustion engine system 20 of FIG. 1. As reflected in FIGS. 1-2, the internal combustion engine system 20 includes a fueling system 21. The fueling system 21 is operable with the internal combustion engine system 20 to provide fueling for the internal combustion engine 30 from a first fuel source 102 and a second fuel source 104. The internal combustion engine system 20 includes an internal combustion engine 30. The internal combustion engine 30 is configured to connect with an intake system 22 for providing a charge flow to internal combustion engine 30 and an exhaust system 24 for output of exhaust gases. In some embodiments, the internal combustion engine 30 is configured as a lean combustion engine such as a diesel cycle engine. In some embodiments, the internal combustion engine 30 is configured as an Otto cycle or spark ignition engine. In some embodiments, the internal combustion engine 30 (e.g., diesel cycle engine, spark ignition engine, etc.) is configurable as a dual fuel engine. More specifically, the dual fuel engine is an engine configured to use a primary fuel from first fuel source 102 (e.g., a liquid fuel such as diesel fuel) and a secondary fuel from the second fuel source 104 (e.g., a gaseous fuel such as hydrogen or natural gas). In some embodiments, the primary fuel and the secondary fuel have different properties such as different auto-ignition temperatures, flame speeds, etc. Speaking generally, in a diesel cycle, the start of combustion is controlled by the timing of the fuel injection. In contrast, a spark ignition cycle is a standard Otto cycle in which the start of ignition is controlled by the spark timing.

In some embodiments, the primary fuel is a liquid fuel, as noted above, and the secondary fuel can be, for example, hydrogen, a mixture containing hydrogen, natural gas, bio-gas, methane, propane, ethanol, producer gas, field gas, liquefied natural gas, compressed natural gas, or landfill gas. However, as discussed in further detail herein, the foregoing are merely examples of fuels, and other types of primary and secondary fuels are not precluded, such as any suitable liquid fuel and gaseous fuel or a combination thereof. For example, in some embodiments, the first fuel is a hydrogen fuel and the second fuel is either ammonia or natural gas. The first fuel and second fuel are combined in a blend that is a mixture containing both fuels. In some embodiments, the first fuel and the second fuel are delivered via separate mechanisms (e.g., the first fuel is delivered via a direct injector and the second fuel is delivered via a different introduction point such as a port injector) and then mixed. In some embodiments, the internal combustion engine is a dual fuel engine configured to receive a mixture of a first fuel and a second fuel, and determining whether to adjust one or more of the plurality of operational parameters includes determining whether to adjust the fuel composition, the fuel composition corresponding to a ratio of the first fuel to the second fuel in the mixture. In some embodiments, the fuel composition is adjusted to attain a target combustion performance.

Further, in some embodiments, the internal combustion engine 30 is one of a spark-ignited engine, a pilot-ignited engine, a compression-ignited engine, or a dual fuel engine. In some embodiments, the internal combustion engine 30 is a port-injected hydrogen fueled engine or a direct-injected hydrogen fueled engine. In some embodiments, the internal combustion engine 30 is at least one of a hydrogen fueled engine, a natural gas fueled engine, a propane fueled engine, or an ammonia fueled engine.

Referring to FIGS. 1-3, the first fuel source 102 includes a first fuel pump 105 that is connected to the controller 200. The second fuel source 104 includes a second fuel pump 106 that is connected to the controller 200. The first fuel pump 105 and the second fuel pump 106 are each configured to provide pressurized fuel. However, in some embodiments such as an internal combustion engine system 20 using gas-phased fuels (e.g., hydrogen, natural gas, etc.), the first fuel pump 105 and/or the second fuel pump 106 may be omitted. As shown in FIGS. 1-2, the internal combustion engine system 20 further includes cylinders 31a, 31b, 31c and 31d. Each of the cylinders 31a-d includes an injector, such as direct injectors 116a-116d or port injectors 118a-118d associated with each of the illustrated cylinders 31a-31d of FIGS. 1-2.

The first fuel pump 105 is connected to each of the direct injectors 116a-116d and/or injectors 118a-118d with a first fuel line 109. The first fuel pump 105 is operable to provide a first fuel flow from first fuel source 102 to each of the cylinders 31a-31d. More particularly, the direct injectors 116a-116d or the port injectors 118a-118d associated with each of the cylinders 31a-31d control the first fuel flow to adjust the first fuel flow and an injection timing for each of the cylinders 31a-31d. The first fuel pump 105 is configured to supply the first fuel flow at any one or more of a rate, amount, and/or timing determined by the controller 200 to produce a desired power and exhaust output from cylinders 31 from the first fuel source 102. The second fuel source 104 is connected to the inlet of a compressor 50 with mixer 117 with a second fuel line 108. A shutoff valve 112 may be provided in the second fuel line 108. The shutoff valve 112 may be provided at one or more other locations in the fueling system 21 that is connected to the controller 200. The second fuel pump 106 is operable to provide a second fuel flow from the second fuel source 104. In particular, the second fuel pump 106 is configured to provide the second fuel flow in an amount determined by the controller 200 to produce a desired power and exhaust output from the cylinders 31 with fuel from the second fuel source 104.

Referring to FIGS. 1-2, as noted above, the internal combustion engine system 20 includes an intake system 22. The intake system 22 includes one or more inlet supply conduits 26 connected to an engine intake manifold 28, which distributes the charge flow to cylinders 31 of engine 30. In some embodiments, the intake system 22 receives the charge flow from a turbocharger 46 upstream of the intake system 22. In some embodiments, the turbocharger 46 is omitted. The intake system 22 includes an intake manifold 28 having an intake port 136 and is configured to distribute the charge flow to the internal combustion engine 30. In some embodiments, the intake system 22 includes an after-cooler and/or an inter-cooler. In some embodiments, the internal combustion engine system 20 includes multiple turbochargers arranged in parallel or in series (e.g., two-stage turbo charging).

Referring to FIGS. 1-2, in some embodiments, the intake system 22 further includes the compressor 50. The compressor 50 compresses fuel from, for example, the second fuel source 104 with the charge flow for delivery to combustion chambers 132 of the plurality of cylinders 31. The intake system 22 further includes a compressor bypass 72 that connects a downstream or outlet side of the compressor 50 to an upstream or inlet side of the compressor 50. The compressor bypass 72 includes a control valve 74 that is selectively opened to allow charge flow to be returned to the inlet side of the compressor 50. The selective opening of the control valve 74 allows compressor surge to be reduced under certain operating conditions, such as when an intake throttle 76 is closed.

Referring to FIGS. 1-2, as mentioned above, the internal combustion engine system 20 includes an exhaust system 24. The exhaust system 24 releases exhaust gases produced by combustion of fuel by the internal combustion engine 30. The exhaust system 24 includes an exhaust manifold 32 having an exhaust port 138 and configured to receive the exhaust gas. The exhaust system 24 includes an exhaust conduit 34 extending from exhaust manifold 32 to the turbine 48 of the turbocharger 46. In one embodiment, the exhaust conduit 34 is fluidly coupled to exhaust manifold 32, and may also include one or more intermediate flow passages, conduits or other structures.

Referring to FIGS. 1-2, as described above, the exhaust conduit 34 extends to the turbine 48 of the turbocharger 46 such as to provide the exhaust gases to the turbocharger 46, although the turbocharger 46 is not required. The turbine 48 may include a controllable wastegate 70 or other suitable bypass that is operable to selectively bypass at least a portion of the exhaust flow from the turbine 48 to reduce boost pressure and engine torque under certain operating conditions. In another embodiment, the turbine 48 is a variable geometry turbine with an inlet that is selectively modulated to permit a desired amount of exhaust flow therethrough.

Referring to FIGS. 1-2, the internal combustion engine 30 includes a cylinder 31 (e.g., a combustion cylinder, etc.). In the embodiment shown in FIGS. 1-2, the internal combustion engine 30 includes four cylinders 31a-31d (collectively referred to as the plurality of cylinders 31) in an in-line arrangement. However, the number of the plurality of cylinders 31 may vary, and the arrangement of the plurality of cylinders 31 may be any arrangement, and is not limited to the number and arrangement shown in FIG. 1. In some embodiments, each of the plurality of cylinders 31 are connected to the intake system 22 to receive the charge flow distributed to each cylinder 31. Further, each cylinder 31 includes a piston 130 and a cylinder head 134. In some embodiments, the cylinder head 134 is not provided with an internal sensor equipped thereto, in contrast to in-cylinder pressure sensor systems. Each of the cylinders 31, its respective piston 130, and the cylinder head 134 form a combustion chamber 132. In the illustrated embodiment, the internal combustion engine 30 includes four such combustion chambers 132. However, it is contemplated that the internal combustion engine 30 may include a greater or lesser number of the cylinders 31 and the combustion chambers 132 and that cylinders 31 and the combustion chambers 132 may be disposed in an in-line configuration, a V-configuration, or in any other suitable configuration. In some embodiments, each of the plurality of cylinders 31 includes at least one injector 116, 118 for delivering fuel to the combustion chamber 132. In some embodiments, the injectors 116, 118, are, for example, direct injectors 116a-116d or port injectors 118a-118d for providing fuel to the cylinders 31.

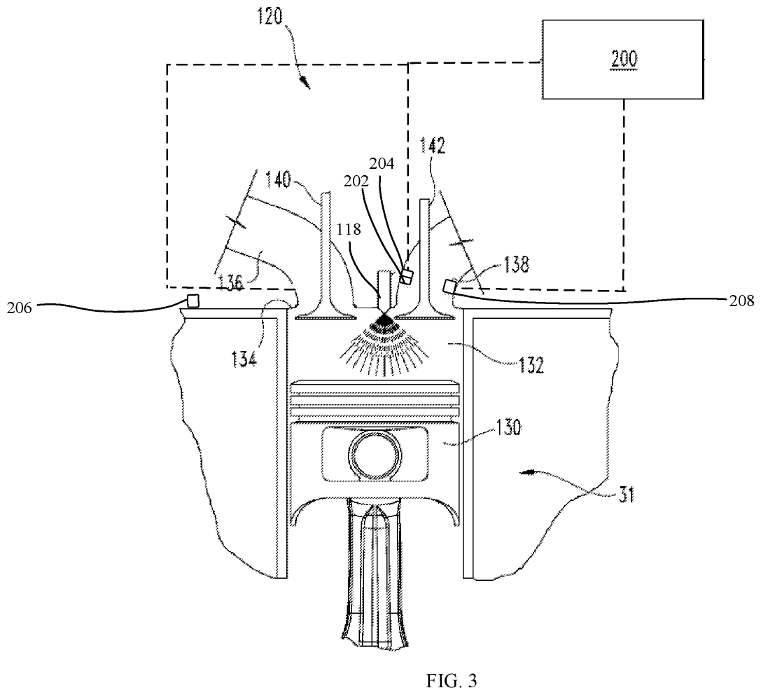

Referring to FIG. 3, the internal combustion engine system 20 includes a control system 120 (e.g., a controller, microcontroller, engine control unit (ECU), etc.). The control system 120 may be configured to, for example, configured to control the plurality of cylinders 31 of the internal combustion engine 30. More specifically, control system 120 may include various control components for tailoring the contribution of a gaseous fuel source from, for example, the second fuel source 104 to the operating conditions in the cylinders 31.

The internal combustion engine system 20 includes a temperature sensor 202 (e.g., thermocouple, thermometer, thermistor, etc.). In some embodiments, the control system 120 is configured to communicate with the temperature sensor 202. In some embodiments, the temperature sensor 202 is coupled to the exhaust manifold 32. More specifically, the temperature sensor 202 is configured to be coupled to an exhaust port 138 of the exhaust manifold 32 or to a part of the exhaust manifold 32 other than the exhaust port 138. Further still, in some embodiments, each of the plurality of cylinders 31 includes a respective temperature sensor 202. The temperature sensor 202 is configured to measure an exhaust gas temperature of exhaust gas.

When balancing combustion performance across the plurality of cylinders 31, measuring the exhaust gas temperature is useful to manage (e.g., reduce, etc.) NOx emissions. NOx emissions can provide a mechanism to control the engine system 20. In some embodiments, the primary object of NOx emissions based control may not be to reduce NOx emissions themselves. For example, in some embodiments, both temperature information from the one or more temperature sensors 202 and NOx information from one or more NOx sensors 204 can be utilized as follows. In this example, a focus of the control is the overall air fuel ratio for the cylinder, and the combustion phasing. Combustion phasing is a function of air/fuel ratio and EGR fraction and ignition timing. Increasing the air fuel ratio or EGR fraction typically lowers the exhaust temperature and lowers the NOx. Retarding the combustion phasing typically lowers the NOx but initially increases the exhaust temperature. Then, as misfire or incomplete combustion sets in, the exhaust temperature lowers. In control schemes that only consider NOx, a situation can arise where NOx is at the target, but combustion is incomplete. Incomplete combustion is undesirable. Control schemes only utilizing NOx information may result in the engine running at an undesirable operating condition, even though NOx targets are met.

Systems described herein utilize NOx information and exhaust temperature information and are capable of recognizing and/or detecting an undesirable operating condition. Systems utilizing both NOx information and temperature information are structured to recognize or detect incomplete combustion. For example, the NOx information can indicate the target value (e.g., a desirable NOx output), but the incomplete combustion results in an exhaust temperature that is too low (e.g., lower than an exhaust temperature threshold or target range). Systems that utilize only the exhaust temperature information can indicate an exhaust temperature that is at the target (e.g., within a desired range) with retarded combustion and a lean (low) air fuel ratio. This can result in NOx output that is below the target, indicating poor engine efficiency. By using both the NOx information and exhaust temperature information, the control system 120 can determine if a change of the ignition timing, air fuel ratio, EGR fraction, or another parameter is desirable.

Cylinder balancing can also be improved by the utilization of both NOx information and temperature information. For example, if all the cylinders are operating the same way, there are techniques to determine if a target operating condition has been attained—for instance, by evaluating the intake manifold pressure, and/or the engine power (e.g. from a generator), or overall lambda in the exhaust with a lambda sensor. However, if significant cylinder to cylinder variation occurs, then typical methods and control schemes do not work. Some cylinders can be too rich (air fuel ratio to low) while others can be too lean (air fuel ratio to high). The control system 120 utilizes NOx information and temperature information to improve response and operation of the engine system 20.

In some embodiments, control system 120 is configured to perform control so as to meet target NOx emissions (e.g., NOx emissions output is within a target range, or below a target threshold) and achieve a desired combustion phasing (e.g., CA50) at a target crank angle. In some embodiments, the control system 120 can adjust the air-fuel ratio (lambda) and the spark timing to achieve desired outcomes. Many combinations of spark timing and lambda can provide the same or similar NOx output. Similarly, different combinations of spark timing and lambda can provide the same or similar exhaust temperature. If both the NOx information and the exhaust temperature information are known (e.g., from the temperature sensor 202 and the NOx sensor 204), the control system 120 can adjust the spark timing and the lambda to achieve a desired combination of NOx output and combustion phasing (e.g., CA50). Combustion phasing (e.g., CA50) can be important because it affects engine performance (e.g., fuel economy, etc.) and can be used for engine calibration.

In some embodiments, if the engine system 20 has a consistent fuel composition, then it is easier to determine how to adjust lambda based on the exhaust NOx level. For example, the control system 120 can target a particular spark timing, which can be adjusted based on a timing table, and the amount of knock sensed. However, in some embodiments, it is likely that the fuel composition will not be fixed or consistent. For example, if the secondary fuel includes natural gas, some hydrogen can be blended in some of the time, and the percentage of hydrogen results in significant changes in combustion. Different spark timing and different lambda values may be advantageous in response to different fuel mixtures.

The exhaust gas NOx amount is driven largely by a highest temperature (e.g., a maximum temperature, etc.) in the cylinder 31. More specifically, NOx production during combustion is directly correlated to an adiabatic flame temperature (AFT) of the fuel mixture, which is the temperature of complete combustion products in the constant volume combustion process without doing work, without heat transfer, or without changes in kinetic or potential energy. Accordingly, cylinders 31 and/or portions of the cylinder 31 with higher exhaust gas temperatures can also exhibit higher exhaust gas NOx amounts. Further, the exhaust gas temperature is also indicative of a ratio of the air and fuel for combustion (e.g., air-fuel ratio, etc.) and combustion timing. This is particularly true for an engine using a fuel mixture having components with a relatively low ignition energy (e.g., amount of energy needed to begin combustion, etc.), such as hydrogen.

In some embodiments, control system 120 is configured to utilize information relating to NOx emissions to control the internal combustion engine system 20. For example, the control system 120 is configured to utilize both an overall air fuel ratio for a cylinder, and combustion phasing. Combustion phasing is a function of the air-fuel ratio, EGR fraction, and ignition timing. Increasing the air-fuel ratio or the EGR fraction typically lowers the exhaust temperature and lowers the NOx. Retarding the combustion phasing typically lowers the NOx but initially increases the exhaust temperature, and then as misfire or incomplete combustion sets in, it lowers the exhaust temperature. If only NOx is considered, then undesirable incomplete combustion may occur despite the NOx being at a target level. In such a circumstance, the engine may be run at undesirable operating conditions, even though the NOx target is nominally met. On the other hand, by considering the exhaust temperature as well, the control system 120 is configured to detect one or more undesirable operating conditions (which would not otherwise be discernible if considering the NOx alone). For example, in a situation in which the NOx is at the target value, and the incomplete combustion results in an exhaust temperature that is too low, the control system 120 is configured to determine that the exhaust temperature is lower than a target value. Similarly, if considering only the exhaust temperature, an exhaust temperature that is at the target value could be obtained with retarded combustion and a lean (high) air fuel ratio. This would result in a NOx value that is below the target, indicating poor engine efficiency. Using both the NOx and exhaust temperature aids in determining whether changes to one or more operational parameters (e.g., ignition timing, air fuel ratio, or EGR fraction) should be made.

Further, in some embodiments, considering performance on a per-cylinder basis allows for assessment of engine performance to account for variations among cylinders. In particular, if each cylinder operates equivalently, factors such as an intake manifold pressure, engine power, or overall air-fuel ratio of the exhaust (as determined using an air-fuel ratio sensor) are indicative of whether target operational conditions are met. However, when significant cylinder to cylinder variation exists, reliance on such parameters does not account for particular air-fuel ratios of individual cylinders. As an example, some cylinders may be too rich (air fuel ratio to low) while others are too lean (air fuel ratio to high). Hence, certain embodiments according to the techniques of the present disclosure provide for measurement on an in-cylinder basis, as discussed below.

Further still, in some embodiments, control system 120 is configured to receive a target exhaust port temperature and a target NOx emissions value. The control system 120 is configured to adjust one or more operational parameters, including the air-fuel ratio and spark timing. Various combinations of spark timing and air-fuel ratio yield an equivalent NOx value or an equivalent exhaust temperature. The control system 120 is configured to adjust the air-fuel ratio based on the NOx level of the exhaust. For example, the control system 120 is configured to adjust a spark timing based on a timing table and an amount of knock sensed. The adjustment of the air-fuel ratio is rendered more difficult when the fuel composition is variable over time and not fixed, e.g., when natural gas is not consistently blended with a same amount of hydrogen or when the natural gas is not always blended with hydrogen. In such circumstances, significant combustion changes mean that different spark timing and air-fuel ratios should be used.

Referring again to FIG. 3, the internal combustion engine system 20 includes a NOx sensor 204. In some embodiments, the control system 120 includes the NOx sensor 204. The NOx sensor 204 is configured to measure an exhaust NOx amount of the exhaust gas. As described above, the exhaust gas NOx amount is correlated to the adiabatic flame temperature (AFT). Accordingly, the exhaust gas NOx amount is affected by a peak AFT as well as a centroid of the heat release location and/or a crank angle associated with approximately 50% heat release (e.g., within the cylinder 31 and/or region of the cylinder 31 with higher exhaust gas temperatures, etc.). In some embodiments, the NOx sensor 204 is coupled to the exhaust manifold 32. In some embodiments, the NOx sensor 204 is coupled to the exhaust port 138 of the exhaust manifold 32 or a portion of the exhaust manifold 32 other than the exhaust port 138. Further still, in some embodiments, each of the plurality of cylinders 31 may include the NOx sensor 204. Although the exemplary, non-limiting embodiments discussed herein provide the temperature sensor 202 and the NOx sensor 204 as separate sensors, in some embodiments, the temperature sensor 202 and the NOx sensor 204 may be combined in a single sensor (e.g., an integrated sensor or combination sensor, etc.). For example, in some embodiments, an integrated sensor is configured to detect a plurality of physical quantities simultaneously, including a temperature and a NOx amount.

In some embodiments, the internal combustion engine system 20 includes a knock sensor 206. In some embodiments, the control system 120 includes the knock sensor 206. The knock sensor 206 is configured to measure engine knock (e.g., identify a knock event, etc.), which is an undesirably premature and rapid combustion associated with engine damage reduced efficiency, and reduced engine power output. Preferably, the knock sensor 206 is coupled to one of the intake manifold 28, the cylinder head 134, or an engine block 35 which at least partially defines the cylinders 31. However, in some embodiments, the knock sensor 206 is coupled to the exhaust manifold 32. In some embodiments, the knock sensor 206 is coupled to the exhaust port 138 of the exhaust manifold 32 or a portion of the exhaust manifold 32 other than the exhaust port 138. Further still, in some embodiments, each of the plurality of cylinders 31 may include the knock sensor 206. Although the exemplary, non-limiting embodiment discussed herein describes the temperature sensor 202, the NOx sensor 204, and the knock sensor 206 as being separate sensors, in some embodiments, the temperature sensor 202, the NOx sensor 204, and the knock sensor 206 may be combined in a single sensor or in any other combination. In some embodiments, the knock sensor is any sensing device, physical or virtual, that determines a knock (e.g., a knock sensor, a cylinder pressure sensor, an ionization sensor, an optical sensor, etc.).

In some embodiments, the internal combustion engine system 20 includes a pressure sensor 208 (e.g., an in-cylinder pressure sensor (ICPS)). In some embodiments, the control system 120 includes the pressure sensor 208. The pressure sensor 208 is configured to measure a signal indicative of one or more of a knock, a peak cylinder pressure, or a heat release rate. In some embodiments, the pressure sensor 208 in the form of an ICPS measures the cylinder pressure. The resulting signal is processed to give an indication of one or more of knock, heat release rate, peak cylinder pressure, combustion phasing (e.g., CA50, a crank angle where approximately 50% of the heat has been released), etc. In some embodiments, the pressure sensor 208 is coupled to the combustion chamber or the cylinder head 134. In some embodiments, the pressure sensor 208 can be positioned elsewhere including one of the intake manifold 28, or an engine block 35 which at least partially defines the cylinders 31. However, in some embodiments, the pressure sensor 208 is coupled to the exhaust manifold 32. Further still, in some embodiments, each of the plurality of cylinders 31 may include the pressure sensor 208. Although the exemplary, non-limiting embodiments discussed herein describe the temperature sensor 202, the NOx sensor 204, the knock sensor 206, and the pressure sensor 208 as being separate sensors, in some embodiments, the temperature sensor 202, the NOx sensor 204, the knock sensor 206, and the pressure sensor 208 may be combined in a single sensor or in any other combination.

Referring to FIG. 3, in some embodiments, the control system 120 includes a controller 200 (e.g., processor, control circuit, etc.). The controller 200 can include one or more of a programmable microcontroller or a microprocessor, a logic circuit, a digital/analog circuit, a programmable logic circuit, a field programmable logic gate array, a memory, etc. The controller 200 receives inputs from one or more components in the control system 120 and provides control signals to actuate one or more actuators or circuits within the control system 120. The controller 200 can be communicably coupled to a memory (volatile or non-volatile), which can store data and instructions that can be executed by the controller. In some instances, the data and instructions can be stored in one or more non-volatile computer readable storage mediums, such as, for example, flash drives, read-only-memories (ROMs), cloud storage, etc.

In the some embodiments, the controller 200 is configured to receive information relating to a plurality of operational parameters of each of the plurality of cylinders 31 of the internal combustion engine 30. For example, the controller 200 may be operably connected (e.g., coupled to, electronically coupled to, attached to, communicatively coupled to, etc.) to the temperature sensor 202 and the NOx sensor 204. The controller 200 may also be communicatively connected to the knock sensor 206. In this way, the controller 200 is able to receive inputs from one or more components in the control system 120 and provide control signals to actuate one or more actuators or circuits within the control system 120. Accordingly, the controller 200 configured to receive the measured exhaust temperature from the temperature sensor 202 and the measured exhaust NOx amount from the NOx sensor 204. In at least some embodiments, the controller 200 is configured to measure, for each of the plurality of cylinders 31 of the internal combustion engine 30, the exhaust temperature from the temperature sensor 202 and the exhaust NOx amount from the NOx sensor 204. In some embodiments, the controller 200 is configured to determine whether a knock event has occurred (e.g., standard knock or silent knock) in response to the measured exhaust temperature and the measured exhaust NOx amount for one or more of the plurality of cylinders 31. Similarly, in some embodiments, the controller 200 is also configured to detect, based on the measured exhaust temperature and the measured NOx amount, silent knock. Silent knock is knocking associated with premature ignition that occurs so early that no audible knock occurs. In such situations, detection by the knock sensor 206 is unlikely. Detection of silent knock is advantageous as silent knock may result in engine damage and undesirably high NOx emissions.

In some embodiments, the controller 200 is further configured to calculate a target combustion performance for an individual cylinder and/or for the overall engine 30. The target combustion performance can be associated with one or more of a higher engine efficiency, a higher engine power output, a reduce emissions level of the cylinder 31 based on the measured exhaust temperature and the measured exhaust NOx amount. In some embodiments, the measured exhaust temperature and the measured exhaust NOx amount are compared to a target exhaust temperature value and a target exhaust NOx amount, respectively, to determine the target combustion performance. The controller 200 is configured to determine a value of the target exhaust temperature and the target exhaust NOx amount from, for example, a look-up table or a predetermined model based on engine operating conditions (e.g., RMP<torque, intake manifold temperature (IMT), intake manifold pressure (IMP), coolant-type, etc.).

The controller 200 is further configured to determine whether to adjust one or more of a plurality of operational parameters based on the target combustion performance. For example, the controller 200 may evaluate, for each of the plurality of cylinders 31, one or more of the plurality of operational parameters with respect to the measured exhaust temperature and the measured exhaust NOx amount. Based on the determination of whether to adjust the one or more operational parameters, the controller 200 is configured to perform an adjustment. For example, the controller 200 is configured to adjust, for one or more of the plurality of cylinders 31, one or more of the plurality of operational parameters to balance combustion across the plurality of cylinders 31 to achieve the target combustion performance. In some embodiments, the controller 200 is further configured to adjust the operational parameters based on the measured engine knock and/or a detected silent knock.

As described above, the controller 200 is configured to receive the measured exhaust temperature and the measured exhaust NOx amount to evaluate the combustion of the internal combustion engine 30, and determine whether to adjust and/or control one or more of a plurality of operational parameters based on the target combustion performance. Although the exhaust NOx amount is largely driven by the adiabatic flame temperature, the exhaust temperature is just one parameter for balancing combustion and may not be indicative of cylinder combustion performance. For example, diluted charge spark ignition and pilot ignited engines can experience charge dilution, where “dilution” refers to adding either air (i.e., leaner air-fuel ratios) or recirculated exhaust gases (EGR) (i.e., higher EGR fraction) to the charge flow. Engines can be operated with charge dilution, either by operating lean, or by using EGR (i.e. adding exhaust gases to the charge). When air is used to dilute the fuel, the air-fuel ratio λ increases. Further, as charge dilution increases, the adiabatic flame temperature drops, which normally reduces the exhaust temperature measured at the exhaust port 138. However, as dilution increases, combustion slows down, causing the combustion event to take place later in the engine cycle. Accordingly, in various exemplary embodiments of the present disclosure, both the measured exhaust NOx amount and the measured exhaust temperature are used to adjust at least one of an air-fuel ratio, a fuel composition, an exhaust gas recirculation fraction, a spark timing value, an injection timing value, a timing of a valve opening or closing event, or a geometric compression ratio, or any combination thereof.

For example, the controller 200 may adjust the spark timing value (e.g., timing of a spark ignition, etc.) to avoid or reduce the likelihood of a knock event in one of the plurality of cylinders 31. As another example, the controller 200 may adjust the lambda λ, an excess air ratio not equal to the air fuel ratio, which is related to the air fuel ratio. According to the embodiments herein, lambda=[air fuel ratio]/[stoichiometric air fuel ratio]. Lambda is an indicator of power output and fuel consumption of the internal combustion engine 30. Accordingly, adjusting the air-fuel ratio λ impacts NOx emissions, engine power output, a knock margin, combustion stability, and the exhaust temperature. As another example, exhaust gas recirculation (EGR) is a process of recirculating exhaust gas back into the cylinder 31 (e.g., using an EGR system, a cooled EGR system, etc.) to reduce both an oxygen concentration and combustion temperature. Therefore, because the exhaust NOx amount is directly related to the combustion temperature, adjusting the exhaust gas recirculation fraction facilitates reduction of the exhaust NOx amount.

In addition to determining whether to adjust operational parameters and/or in addition to performing an adjustment of the operational parameters, the controller 200 may also determine whether an overall engine combustion performance differs from a target engine performance. For example, the controller 200 may be configured to adjust an overall internal combustion engine air-fuel ratio and an overall internal combustion engine exhaust gas recirculation fraction in response to the measured exhaust temperature and the measured exhaust NOx amount.

In some embodiments, a method for controlling an internal combustion engine is carried out. The method according to some embodiments includes measuring both exhaust temperature and a NOx amount (i.e., an amount of NOx in the exhaust gases). The method further includes receiving information relating to one or more operational parameters including but not limited to an engine speed, an engine load, an intake manifold temperature of an engine (i.e., the temperature of the air or charge inside the intake manifold, rather than the temperature of the metal), an oil temperature, a coolant temperature, an ambient air temperature, intake manifold pressure, intake throttle position, ignition timing, turbo RPM, etc. The method includes calculating a target exhaust temperature and a target NOx amount based on a plurality of the operational parameters. The method further includes comparing the measured exhaust temperature and the measured NOx amount to the target exhaust temperature and the target NOx amount. The method further includes adjusting one or more engine parameters, where the engine parameters include, but are not limited to, an air-fuel ratio, a spark timing, and an EGR fraction, for example. More particularly, the method further includes adjusting the one or more engine parameters to reduce (i) the difference between the measured exhaust temperature and the target exhaust temperature and/or (ii) the difference between the measured NOx amount and the target NOx amount. The foregoing operations are repeatable iteratively.

In some embodiments, a method for controlling an internal combustion engine includes one or more cylinder-specific measurements. In particular, the method includes measuring both exhaust temperature and a NOx amount. The method further includes comparing the measured exhaust temperature and the measured NOx amount for each cylinder of a plurality of cylinders of the internal combustion engine. The method further includes adjusting one or more operational parameters of an individual cylinder. The operational parameters include, but are not limited to, a fuel flow rate, an air flow rate, a spark timing, and a camshaft phasing. In particular, the method includes adjusting one or more operational parameters of an individual cylinder in order to harmonize the measured exhaust temperature and the measured NOx amount among the plurality of cylinders. In particular, the one or more operational parameters of each cylinder are adjusted until each cylinder is within a certain tolerance band for both exhaust temperature and NOx amount. As an example, the method includes adjusting one or more operational parameters until each individual cylinder is within ±5° C., within ±10° C. or within ±15° C. of a given exhaust temperature (e.g., an average exhaust temperature across all cylinders, or a target exhaust temperature determined by consulting a look-up table). As a further example, the method includes adjusting one or more operational parameters until each individual cylinder is within ±5%, within ±7.5% or within ±10% of a given NOx amount (e.g., an average NOx amount across all cylinders, or a target NOx amount determined by consulting a look-up table). In some embodiments, the method can continuously adjust to lower or even minimize a difference between individual cylinders. In some embodiments, the method is considered to produce a successful result if the difference is 5%, even when the goal is 0%. For example, the control system 120 may include a threshold difference (e.g., 5%). While the method is operable to achieve a 0% difference, adjustments can be stopped by control system 120 once the threshold difference is reached.

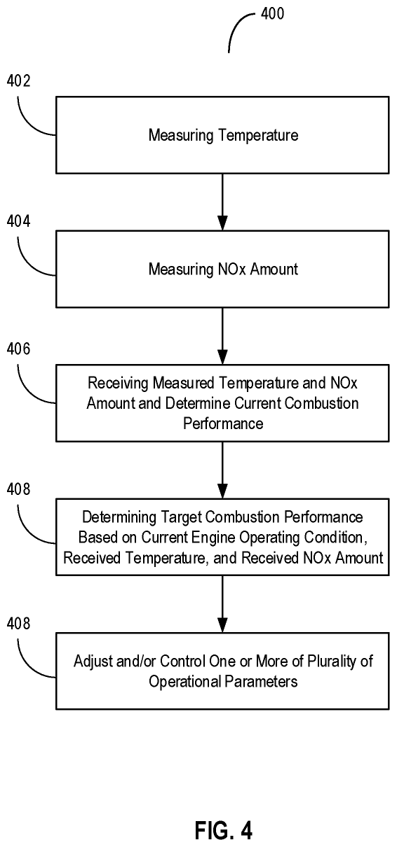

FIG. 4 illustrates a method 400 (e.g., process, etc.) of controlling an internal combustion engine system 20 (e.g., by using the control system 120, etc.). The operations described below are exemplary and non-limiting, and in some embodiments, include optional operations which may be omitted and operations which can be performed in a different order than that described.

The method 400 for controlling an internal combustion engine system 20 shown in FIG. 4 is implementable in any of the engines described in the present disclosure, by way of example and not by way of limitation. In some embodiments, the method 400 includes measuring, by a temperature sensor 202 of a cylinder 31 of the internal combustion engine 30, an exhaust temperature of an exhaust gas of the cylinder 31; measuring, by a NOx sensor 204 of the cylinder 31, an exhaust NOx amount of the exhaust gas; receiving, by a controller 200, the measured exhaust temperature and the measured exhaust NOx amount from the temperature sensor 202 and the NOx sensor 204; determining a target combustion performance of the cylinder 31 based on the measured exhaust temperature and the measured exhaust NOx amount; and determining whether to adjust one or more of a plurality of operational parameters and controlling the one or more of the plurality of operational parameters based on the target combustion performance.

The method 400 begins in step 402 by measuring, by the temperature sensor 202 of the cylinder 31 of the internal combustion engine 30, the exhaust temperature of the exhaust gas of the cylinder 31. The method 400 continues in step 404 by measuring, by the NOx sensor 204 of the cylinder 31, the exhaust NOx amount of the exhaust gas.

In some embodiments, step 402 and step 404 include measuring the exhaust temperature and the NOx amount, respectively, of the exhaust gas in the exhaust manifold 32 or the exhaust port 138 of the cylinder 31 of the internal combustion engine 30, the temperature sensor 202 and the NOx sensor 204 being coupled to the exhaust manifold 32 or the exhaust port 138.

The method 400 continues in step 406 by receiving, by the controller 200, the measured exhaust temperature and the measured exhaust NOx amount from the temperature sensor 202 and the NOx sensor 204, respectively. Additionally, in some embodiments, the controller 200 can receive engine operating conditions including one or more of RPM, load, intake manifold temperature, intake manifold pressure, oil temperature, coolant temperature, ambient air pressure, injection pressure, injection timing or duration, ignition timing (e.g., spark ignited, etc.), fuel flow rates, air flow rates, EGR rates, etc. In some embodiments, the controller 200 determines a current combustion performance for the engine or for each cylinder using the received temperature, NOx amount, and engine operating conditions.

The method 400 continues in step 408 by determining the target combustion performance of the cylinder 31 based on the measured exhaust temperature and the measured exhaust NOx amount. In some embodiments, the target combustion performance is also based on the engine operating conditions. In some embodiments, the target combustion performance is a dynamic parameter that changes over time and is a function of the engine operating conditions.

The method 400 continues in step 410 by determining whether to adjust one or more of a plurality of operational parameters and controlling the one or more of the plurality of operational parameters based on the target combustion performance. In some embodiments, the controller 200 compares the current combustion performance and the target combustion performance to determine a difference. The controller 200 can then adjust the operational parameters of the engine to minimize the difference between the current combustion performance and the target combustion performance.

In some embodiments, the controller 200 compares the measured exhaust temperature and the measured exhaust NOx amount to the target combustion performance. Based on the comparison, an error term is determined for NOx and exhaust temperature. The controller 200 then makes one or more adjustments to the engine parameters (e.g., air-fuel ratio, spark timing, EGR fraction) to minimize the error term for NOx and exhaust temperature.

In some embodiments, the controller 200 compares the measured values of exhaust temperature and exhaust NOx amount for each the different cylinders separately. The controller 200 then makes adjustments to one or more individual cylinders (e.g., fuel flow rate, air flow rate, spark timing, camshaft phasing, etc.) so that the exhaust temperature and exhaust NOx amount measured for all the cylinders are within a certain tolerance band (e.g., ±10 degrees Celsius, or ±5% of the measured NOx amount).

In some embodiments, the step 410 of determining whether to adjust one or more of a plurality of operational parameters and controlling the one or more of the plurality of operational parameters based on the target combustion performance, includes determining whether to adjust one or more of the following parameters. The one or more operational parameters include, but are not limited to, an air-fuel ratio, a fuel composition, an exhaust gas recirculation fraction, a spark timing value, an injection timing value (e.g., an injection duration and/or an injection pressure), a timing of a valve opening or closing event, an intake and/or exhaust throttle position, a wastegate position, a compressor bypass valve position, a position of a variable geometry turbo, or a geometric compression ratio. In some embodiments, the operational parameters are applied to individual cylinders (e.g., cylinder specific control). In some embodiments, the operational parameters are applied on a per-bank basis (e.g., to each bank individually and separately). In some embodiments, the operational parameters are applied on an engine level to all cylinders. In some embodiments, the determination of whether to adjust one or more of these parameters may be based on any combination of the foregoing parameters. As an example, the controller 200 is configured to determine whether to adjust one or more of the operational parameters based on an inputted fuel composition of a dual fuel mixture. In some embodiments, the controller 200 receives information relating to the fuel composition as a ratio of the two fuels of the dual fuel mixture.

The method 400 optionally includes adjusting, by the controller 200, one or more of the plurality of operational parameters to balance combustion performance among a plurality of cylinders 31. The method 400 optionally includes measuring a knock via the knock sensor 206 coupled to the engine 30, and adjusting, by the controller 200, an overall internal combustion engine air-fuel ratio and an overall internal combustion engine exhaust gas recirculation fraction in response to the detected knock, the measured exhaust temperature, and the exhaust measured NOx amount for each cylinder 31 of the plurality of cylinders 31 of the internal combustion engine 30.

Although the exemplary, non-limiting embodiment of method 400 described above includes the step 402 before the step 404, the method 400 is not so limited. Rather, step 402 and step 404 can occur in any order (i.e., step 402 . . . 404, step 404 . . . 402) and/or can occur simultaneously.

While this specification contains various implementation details, these should not be construed as limitations on the scope of what may be claimed but rather as descriptions of features specific to particular implementations. For example, an engine described in connection with a particular fuel or fuel mixture may be configured to receive a different fuel or fuel mixture. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, liquid, reductant, an air-reductant mixture, exhaust gas, hydrocarbon, an air-hydrocarbon mixture, may flow, either with or without intervening components or objects. Examples of fluid couplings or configurations for enabling fluid communication may include piping, conduits, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

The term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the various systems and the operations according to various techniques shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

1-24. (canceled)

25. A control system for an internal combustion engine, the control system comprising:
a temperature sensor configured to measure an exhaust temperature from a cylinder of the internal combustion engine;
a NOx sensor configured to measure an exhaust NOx amount from the cylinder; and
a controller operably connected to the temperature sensor and the NOx sensor, the controller configured to:
receive the measured exhaust temperature from the temperature sensor and the measured exhaust NOx amount from the NOx sensor;
calculate a current combustion performance of the cylinder based on the measured exhaust temperature and the measured exhaust NOx amount;
determine whether to adjust one or more of a plurality of operational parameters; and
control the one or more of the plurality of operational parameters based on the current combustion performance.

26. The control system of claim 25, wherein the controller is configured to determine whether to adjust the plurality of operational parameters including at least one of an air-fuel ratio, a fuel composition, an exhaust gas recirculation fraction, a spark timing value, an injection duration and an injection pressure, a timing of a valve opening or closing event, or a geometric compression ratio.

27. The control system of claim 25, wherein the cylinder is one of a plurality of cylinders of the internal combustion engine, each of the plurality of cylinders having a respective NOx sensor and a respective temperature sensor.

28. The control system of claim 27, wherein the controller is configured to control the current combustion performance of each of the plurality of cylinders to balance a collective combustion performance among the plurality of cylinders.

29. The control system of claim 25, wherein the controller is configured to adjust at least one of an overall internal combustion engine air-fuel ratio or an overall internal combustion engine exhaust gas recirculation fraction in response to the measured exhaust temperature and the measured exhaust NOx amount.

30. The control system of claim 25, wherein the controller is configured to determine a target combustion performance based on engine operating conditions;
compare the current combustion performance to the target combustion performance; and
control the one or more of the plurality of operational parameters based on the comparison of the current combustion performance and the target combustion performance.

31. An internal combustion engine system configured to control combustion, the internal combustion engine system comprising:
an internal combustion engine comprising a plurality of cylinders, each having a temperature sensor and a NOx sensor; and
a control system configured to control the plurality of cylinders of the internal combustion engine, the control system comprising a controller configured to:
receive information relating to a plurality of operational parameters of each of the plurality of cylinders of the internal combustion engine;
measure, for each of the plurality of cylinders of the internal combustion engine, an exhaust temperature from the temperature sensor and an exhaust NOx amount from the NOx sensor;
evaluate, for each of the plurality of cylinders of the internal combustion engine, one or more of the plurality of operational parameters with respect to the measured exhaust temperature and the measured exhaust NOx amount; and
adjust, for one or more of the plurality of cylinders of the internal combustion engine, one or more of the plurality of operational parameters to control the combustion among the plurality of cylinders.

32. The internal combustion engine system of claim 31, wherein each cylinder of the plurality of cylinders comprises an exhaust manifold or an exhaust port configured to receive an exhaust gas, the temperature sensor and the NOx sensor being coupled to the exhaust manifold or the exhaust port to measure the exhaust temperature and the exhaust NOx amount of the exhaust gas.

33. The internal combustion engine system of claim 31, wherein the controller is configured to receive information relating to the plurality of operational parameters including (i) an exhaust gas recirculation fraction of an exhaust gas recirculation system of the internal combustion engine, (ii) a spark timing value of an ignition system of the internal combustion engine, (iii) an injection duration and an injection pressure of a fuel injection system of the internal combustion engine, (iv) a timing of a valve opening or closing event of a cam of the internal combustion engine, (v) an air-fuel ratio of the internal combustion engine, (vi) a geometric compression ratio of one or more of the plurality of cylinders of the internal combustion engine, and (vii) a fuel composition, and
wherein the controller is configured to receive information relating to each of the plurality of operational parameters to evaluate the combustion of the internal combustion engine.

34. The internal combustion engine system of claim 33, further comprising a knock sensor communicatively coupled to the controller and configured to measure engine knock,
wherein the controller is configured to adjust the one or more operational parameters based on the measured engine knock and, for one or more of the plurality of cylinders, the measured exhaust temperature and the measured exhaust NOx amount.

35. The internal combustion engine system of claim 33, wherein the controller is configured to determine whether an overall engine combustion performance differs from a target engine performance, and to adjust at least one of an overall internal combustion engine air-fuel ratio and an overall internal combustion engine exhaust gas recirculation fraction in response to the measured exhaust temperature and the measured exhaust NOx amount for one or more cylinder of the plurality of cylinders.

36. The internal combustion engine system of claim 33, wherein the internal combustion engine is one of a spark-ignited engine, a pilot-ignited engine, a compression-ignited engine, a dual fuel engine, a port-injected hydrogen fueled engine, a direct-injected hydrogen fueled engine, a hydrogen fueled engine, a natural gas fueled engine, a propane fueled engine, or an ammonia fueled engine.

37. The internal combustion engine system of claim 33, wherein the controller is configured to determine whether a knock event has occurred in response to the measured exhaust temperature and the measured exhaust NOx amount for one or more of the plurality of cylinders.

38. A method for controlling an internal combustion engine system, the method comprising:
measuring, by a temperature sensor of a cylinder of an internal combustion engine, an exhaust temperature of an exhaust gas of the cylinder;
measuring, by a NOx sensor of the cylinder, an exhaust NOx amount of the exhaust gas;
receiving, by a controller, the measured exhaust temperature and the measured exhaust NOx amount from the temperature sensor and the NOx sensor;
determining a target combustion performance of the cylinder based on the measured exhaust temperature and the measured exhaust NOx amount;
determining whether to adjust one or more of a plurality of operational parameters; and
controlling the one or more of the plurality of operational parameters based on the target combustion performance.

39. The method of claim 38, further comprising adjusting, by the controller, one or more of the plurality of operational parameters to balance combustion performance among a plurality of cylinders.

40. The method of claim 38, further comprising:
measuring a knock via a knock sensor coupled to the engine; and
adjusting, by the controller, at least one of an overall internal combustion engine air-fuel ratio or an overall internal combustion engine exhaust gas recirculation fraction in response to the detected knock, the measured exhaust temperature, and the exhaust measured NOx amount for each cylinder of the plurality of cylinders of the internal combustion engine.

41. The method of claim 38, wherein measuring the exhaust temperature and the NOx amount of the exhaust gas of the cylinder of the internal combustion engine includes measuring the exhaust temperature and the NOx amount of the exhaust gas in an exhaust manifold or an exhaust port of the cylinder of the internal combustion engine, the temperature sensor and the NOx sensor being coupled to one of the exhaust manifold or the exhaust port.

42. The method of claim 38, wherein the internal combustion engine is a dual fuel engine configured to receive a mixture of a first fuel and a second fuel, and wherein determining whether to adjust one or more of the plurality of operational parameters comprises determining whether to adjust the fuel composition, the fuel composition corresponding to a ratio of the first fuel to the second fuel in the mixture.

43. The method of claim 42, further comprising adjusting the fuel composition to attain a target combustion performance.

44. The method of claim 42, wherein determining whether to adjust one or more of the plurality of operational parameters comprises determining whether to adjust the ratio of the first fuel, the first fuel including hydrogen, to the second fuel, the second fuel including natural gas or ammonia, in the mixture.
